(19) United States
(12) Patent Application Publication
(10) Pub. No.: US 2012/0032988 A1
(43) Pub. Date: Feb. 9, 2012

(54) DISPLAY CONTROL APPARATUS THAT DISPLAYS LIST OF IMAGES ONTO DISPLAY UNIT, DISPLAY CONTROL METHOD, AND STORAGE MEDIUM STORING CONTROL PROGRAM THEREFOR

(75) Inventor: Tatsushi KATAYAMA, Kawasaki-shi (JP)

(73) Assignee: CANON KABUSHIKI KAISHA, Tokyo (JP)

(21) Appl. No.: 13/197,834

(22) Filed: Aug. 4, 2011

(30) Foreign Application Priority Data
Aug. 4, 2010 (JP) 2010-175571

(51) Int. Cl. G09G 5/00

(52) U.S. Cl. 345/684

(57) ABSTRACT

A display control apparatus that is capable of searching for a desired image from massive images listed by scrolling on a display unit. The display control apparatus controls a display unit to display a list of images. A display control unit controls so that the images are displayed in a predetermined order on the display unit. A scrolling control unit controls so as to scroll the images displayed on the display unit. A control unit configured to control the display control unit to decrease the number of images displayed in a screen and to increase a size of the displayed images when the scrolling control unit changes scrolling speed from low speed to high speed.

### BACKGROUND OF THE INVENTION

1. Field of the Invention

The present invention relates to display control for displaying a list of images onto a display unit, and particularly, relates to a technique about display control for scrolling images.

2. Description of the Related Art

Some digital cameras have an index function that lists reduced picked-up images when displaying the picked-up images read from a recording medium onto a display unit like a liquid crystal display.

For example, Japanese Laid-Open Patent Publication (Kokai) No. 2000-125251 (JP 2000-125251A) discloses a technique that displays thumbnail images onto a display unit in a two-dimensional rectangular arrangement so as to enable to scroll a screen of the display unit in at least one of vertical and horizontal directions.

This technique keeps continuity among screens by displaying thumbnail images, which were located at a bottom in a screen before scrolling, at a top of a screen after scrolling.

Japanese Laid-Open Patent Publication (Kokai) No. 2005-275034 (JP 2005-275034A) discloses a technique that displays desired images, which have been selected by a user from thumbnail images displayed on a display unit, in a screen one by one.

This technique enables to operate a desired image efficiently by enlarging only the selected image and arranging it at the top of the screen.

Incidentally, when checking massive images stored in a mass storage medium, it is efficient to search by scrolling thumbnail images displayed on a display unit. Here, quick search for a desired image from massive thumbnail images requires to accelerate scrolling.

However, JP 2000-125251A is difficult to grasp a content of a thumbnail image when increasing the scrolling speed of the thumbnail images because of small size of the thumbnail image during scrolling.

JP 2005-275034A displays only the thumbnail image selected by a user in large size, which increases workload for selecting the desired image to be displayed in large size. Particularly, when a plurality of images are desired to be enlarged, it becomes difficult to search desired images quickly from massive thumbnail images.

### SUMMARY OF THE INVENTION

The present invention provides a mechanism that is capable of searching for a desired image from massive images listed by scrolling on a display unit.

Accordingly, a first aspect of the present invention provides a display control apparatus that controls a display unit to display a list of images, comprising a display control unit configured to control so that the images are displayed in a predetermined order on the display unit, a scrolling control unit configured to control so as to scroll the images displayed on the display unit, and a control unit configured to control the display control unit to decrease the number of images displayed in a screen and to increase a size of the displayed images when the scrolling control unit changes scrolling speed from low speed to high speed.

Accordingly, a second aspect of the present invention provides a control method for a display control apparatus that controls a display unit to display a list of images, the control method comprising a display control step of controlling so that the images are displayed in a predetermined order on the display unit, a scrolling control step of controlling so as to scroll the images displayed on the display unit, and a control step of controlling so as to decrease the number of images displayed in a screen in the display control step and to increase a size of the displayed images when the scrolling speed is changed from low speed to high speed in the scrolling control step.

Accordingly, a third aspect of the present invention provides A non-transitory computer-readable storage medium storing a control program causing a computer to execute a control method for a display control apparatus that displays a list of images on a display unit, the control method comprising a display control step of controlling so that the images are displayed in a predetermined order on the display unit, a scrolling control step of controlling so as to scroll the images displayed on the display unit, and a control step of controlling so as to decrease the number of images displayed in a screen in the display control step and to increase a size of the displayed images when the scrolling speed is changed from low speed to high speed in the scrolling control step.

According to the present invention, since the variation of the scrolling speed of the index screen from low speed to high speed increases the image size and decreases the number of images displayed in a screen, the visibility of picked-up images during scrolling improves. Accordingly, a user can quickly search a desired image from massive images listed onto the display unit during scrolling.

Further features of the present invention will become apparent from the following description of exemplary embodiments with reference to the attached drawings.

### BRIEF DESCRIPTION OF THE DRAWINGS

FIG. 1A is an external view showing a digital camera as an example of a display control apparatus to which embodiments of the present invention can be applied.

FIG. 1B is a block diagram schematically showing an electrical configuration of the digital camera shown in FIG. 1A.

FIG. 2A, FIG. 2B, and FIG. 2C are views showing an example of time-variations of an index screen displayed onto a display unit when a user performs a scrolling operation to a cross key of an operation unit of the digital camera shown in FIG. 1A.

FIG. 3A through FIG. 3F are views showing an example of display modes of the index screen on the display unit corresponding to scrolling speed changed by an operation of the cross key.

FIG. 4 is a graph showing a relationship between a period during which the cross key is pushed and held in a predetermined direction (a holding time) and a scrolling time per screen.

FIG. 5 is a flowchart showing an example of an operation of the digital camera shown in FIG. 1A.

FIG. 6 is a view showing a list of priority flags determined by the process in FIG. 5.

FIG. 7 is a view showing an example of priority order table used in the process in FIG. 5.

FIG. 8 is a flowchart showing a displaying image selection/enlargement process executed in the step S1005 in FIG. 5.

FIG. 9A through FIG. 9D are views showing an example of display modes of the index screen corresponding to moving speed of a finger on a touch sensor.

FIG. 10 is a flowchart showing an example of an operation of a digital camera as a display control apparatus according to a second embodiment of the present invention.

### DESCRIPTION OF THE EMBODIMENTS

Hereafter, embodiments according to the present invention will be described in detail with reference to the drawings.

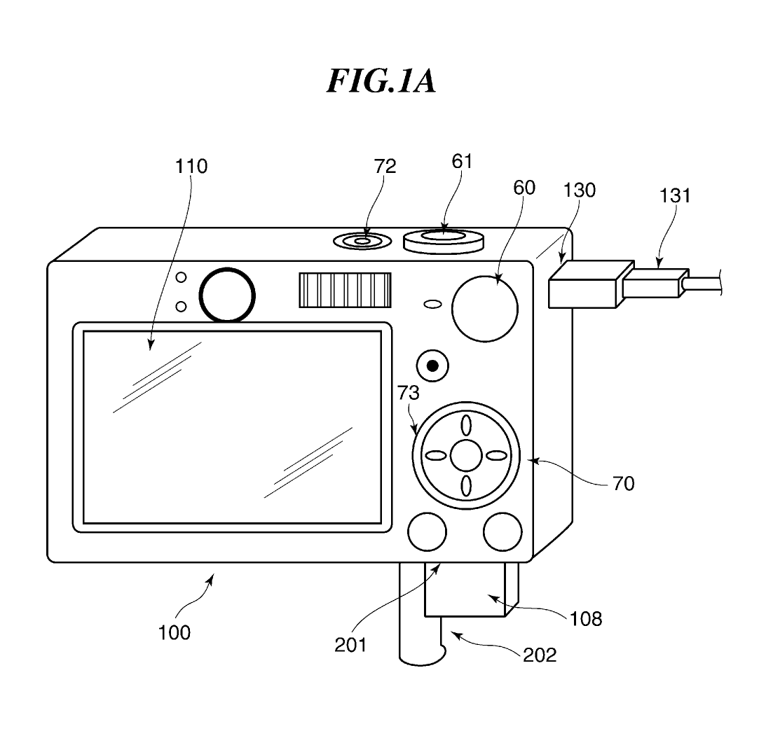

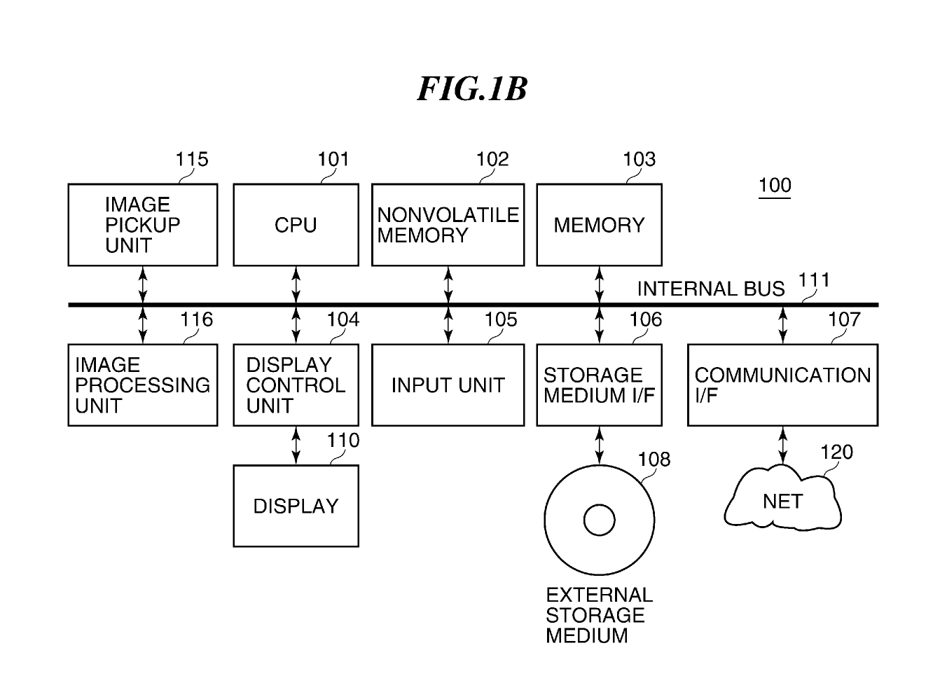

FIG. 1A is an external view showing a digital camera 100 as an example of a display control apparatus to which embodiments of the present invention can be applied. A display unit 110 displays an image and a variety of information. A touch panel is overlaid on the display unit 110 to enable a touch operation to the display unit 110.

A shutter button 61 is an operation unit for instructing shooting. A mode dial 60 is an operation unit for changing various modes. A connector 130 connects a communication I/F (interface) 107 mentioned later to a connecting cable 131. A cross key 70 is a direction button that receives various operations from a user, and can be operated in four directions including an up direction, a down direction, a left direction, and a right direction. Although the cross key 70 is described as a single operating member here, as long as it can operate in the four directions, four independent buttons arranged at a cross are sufficient.

A controller wheel 73 is an operating member that can receive a rotary operation, and is used for instructing selections in cooperation with the cross key 70. A rotary operation of the controller wheel 73 generates an electric pulse signal by which a CPU 101 controls units of the digital camera 100. A rotation angle and the number of rotation of the controller wheel 73 can be determined based on the pulse signal.

It should be noted that the controller wheel 73 may be any operating member that can detect a rotary operation. For example, the controller wheel 73 may be a dial operating member that generates the pulse signal by a rotation of itself according to a user's rotary operation. Alternatively, the controller wheel 73 may be an operating member that consists of touch sensors and detects a rotary operation of a user's finger on the controller wheel 73 without rotating the controller wheel 73 itself (a touch wheel).

A power switch 72 switches ON/OFF of a power supply. The touch panel overlaid on the display unit 110, the power switch 72, the shutter button 61, the mode dial 60, the cross key 70, and the controller wheel 73 are operating members included in an input unit 105 mentioned later.

An external storage medium 108 is a memory card, a hard disk, etc. A storage medium slot 201 is a slot for storing the external storage medium 108. The external storage medium 108 stored in the storage medium slot 201 can communicate with the digital camera 100 via a storage-medium I/F 106. A cover 202 closes the storage medium slot 201.

FIG. 1B shows an example of an electrical configuration of the digital camera 100 shown in FIG. 1A.

In FIG. 1B, the CPU 101, a nonvolatile memory 102, a memory 103, a display control part 104, the input unit 105, the storage-medium I/F 106, the communication I/F 107, an image pickup unit 115, and an image processing unit 116 are connected to an internal bus 111. The units that are connected to the internal bus 111 can mutually exchange data via the internal bus 111.

The image pickup unit 115 comprises an image pickup lens, an image pickup device, etc. The image processing unit 116 applies a pixel interpolation process, a development process, a color process, a reducing process, an encoding process, a compression process, etc. to image data of a moving image or a static image picked up by the image pickup unit 115. The processed image data is recorded into the external storage medium 108 as an image file. The image processing unit 116 applies various processes, such as a decompression process, a decoding process, the color process, a resizing process, for displaying an image on the display unit 110 to the image file read from the external storage medium 108. It should be noted that the display unit 110 functions as an electronic view finder (a through image display) by converting the image signal picked up by the image pickup unit 115 into a digital image signal by an A/D conversion, storing the digital image signal into the memory 103, converting the digital image signal stored into an analog image signal, and transmitting the analog image signal sequentially to the display unit 110 for displaying.

The nonvolatile memory 102 stores image data, other data, various programs for operating the CPU 101, etc. The nonvolatile memory consists of a hard disk (HD), a ROM, etc. The memory 103 consists of a RAM, for example. The CPU 101 controls the units of the digital camera 100 according to the programs stored in the nonvolatile memory 102, for example, while using the memory 103 as a work memory.

The input unit 105 receives a user's operation, generates a control signal corresponding to the operation, and supplies it to the CPU 101. For example, the input unit 105 has the above-mentioned various operating members like the touch panel as input devices that receive user's operations. It should be noted that the touch panel is an input device that outputs coordinate information corresponding to a position at which a user's fingertip contacts in the planar input unit, for example. The CPU 101 controls the units of the digital camera 100 according to the program based on the control signal that is generated by the input unit 105 corresponding to the user's operations to the input devices and is supplied from the input unit 105. Accordingly, the digital camera 100 acts according to the user's operations.

The display control unit 104 outputs a display signal for displaying an image on the display unit 110. For example, a display control signal generated by the CPU 101 according to the program is supplied to the display control unit 104. The display control unit 104 generates a display signal based on the display control signal, and outputs it to the display unit 110. For example, the display control unit 104 controls the display unit 110 to display a GUI (Graphical User Interface) screen based on the display control signal generated by the CPU 101.

When the input unit 105 is provided with the touch panel, the input unit 105 and the display unit 110 can be united. For example, the touch panel of which transmittance is high so as not to obstruct the display of the display unit 110 is overlaid on the display surface of the display unit 110. Then, the input coordinate on the touch panel is associated with the display coordinate on the display unit 110. This can constitute a GUI that looks as if a user can directly operate the screen displayed on the display unit 110.

The external storage media 108 like a memory card can be connected to the storage-medium I/F 106. The CPU 101 controls the storage-medium I/F 106 to read data from the external storage medium 108 connected, and to write data into the external storage medium 108 concerned. The CPU 101 controls the communication I/F 107 so as to communicate with an external device connected via a communication cable 131, and with networks 120 such as a LAN and the Internet.

It should be noted that the CPU 101 can detect the following operations to the touch panel included in the input unit 105. An operation of a finger or a pen to touch the touch panel (referred to as a touch-down hereafter). A state to keep the finger or the pen touching the touch panel (referred to as a touch-on hereafter). An operation of the finger or the pen to move while touching the touch panel (referred to as a move hereafter). An operation to detach the finger or the pen that has touched the touch panel (referred to as a touch-up hereafter). A state where nothing touches the touch panel (referred to as a touch-off hereafter).

These operations and the position coordinate at which the finger or the pen are touching the touch panel are notified to the CPU 101 through the internal bus 111, and the CPU 101 determines what operations were given on the touch panel based on the notified information. Regarding the move operation, the direction of the movement of the finger or the pen that moves on the touch panel can be determined as a vertical component and a horizontal component based on the change of the position coordinate.

A continuous operation of the touch-down, the move, and the touch-up on the touch panel draws a stroke. An operation to draw a stroke quickly is called a flick. The flick is an operation to move a finger while touching the touch panel in a certain distance quickly, and to detach the finger. In the other words, the flick is an operation to follow the touch panel quickly so as to snap the touch panel with the finger.

When the move operation beyond a predetermined distance and beyond a predetermined speed is detected and the touch-up is then detected, it is determined that the flick operation has been performed. When the move operation beyond the predetermined distance in speed less than the predetermined speed is detected, it is determined that a drag has been performed. The touch panel can use any of various systems such as a resistance film system, a capacitive sensing method, a surface acoustic wave system, an infrared system, an electromagnetic induction type, an image recognition system, a photosensor system.

Next, operations of first and second embodiments according to the present invention will be described.

In the first embodiment, when the scrolling speed becomes higher when index images are displayed in the scrolling process, the number of images displayed in one screen decreases and the size of each image increases. This improves the visibility even if the scrolling speed becomes high, which enables a user to find a desired image certainly and quickly. In this embodiment, a user can instruct vertical scrolling by one of the following methods.

(1) An operation (push) of the cross key 70 upward instructs a downward scrolling (a scrolling for moving displayed images from top to bottom, and for displaying hidden images arranged over the top). Conversely, an operation (push) of the cross key 70 downward instructs an upward scrolling (a scrolling for moving displayed images from bottom to top, and for displaying hidden images arranged under the bottom). The scrolling speed increases as the time of pushing the cross key 70 in the same direction becomes longer.

(2) A rotary operation of the controller wheel 73 clockwise instructs the upward scrolling, and a rotary operation of the controller wheel 73 counterclockwise instructs the downward scrolling. The scrolling speed increases as the rotation speed of the rotary operation increases.

(3) An upward drag or an upward flick on the touch panel instructs the upward scrolling. A downward drag or a downward flick instructs the downward scrolling. The scrolling speed increases as the moving speed of the touch position by the drag or the flick becomes faster.

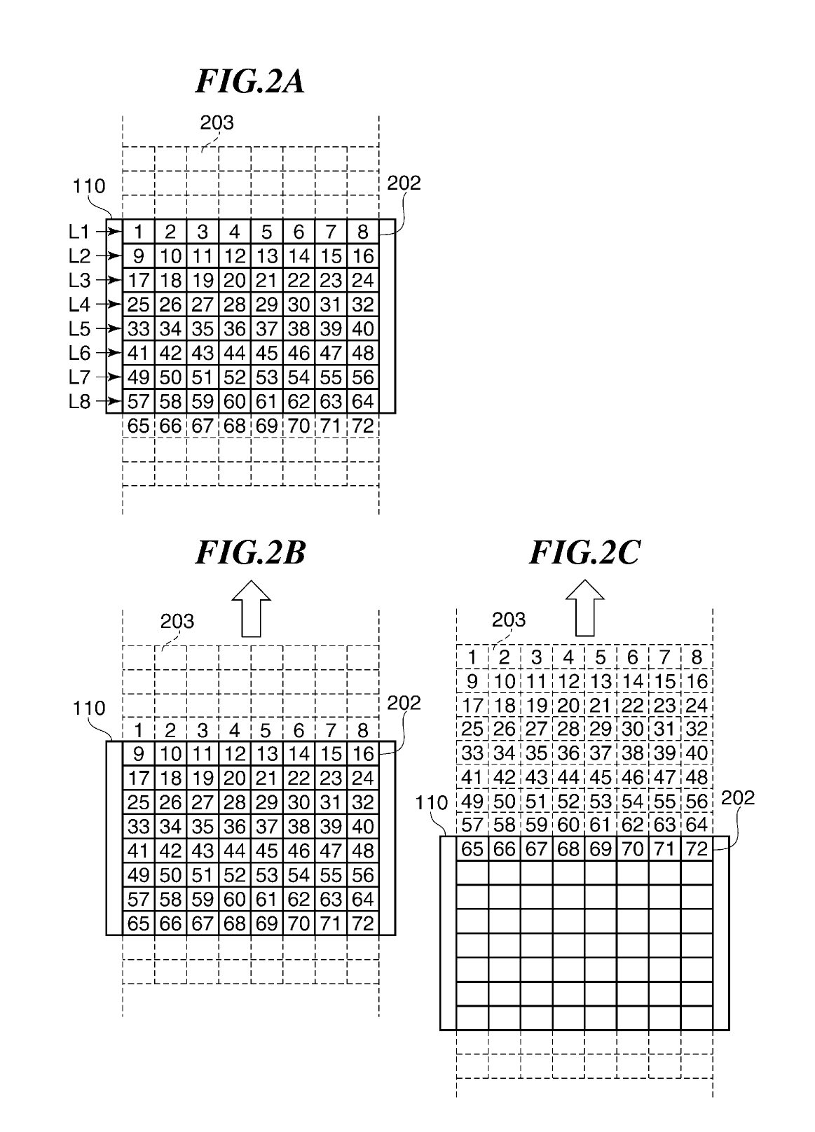

FIG. 2A, FIG. 2B, and FIG. 2C are views showing an example of time-variations of an index screen displayed onto the display unit 110 when a user performs the scrolling operation.

Massive images stored in the external storage medium 108 are fitted in rectangular frames 203 arranged across an index screen 202 displayed on the display unit 110 as shown in FIG. 2A through FIG. 2C. In FIG. 2A, the display unit 110 displays the index screen 202 that consists of 64 images (the numbers 1 through 64) that are arranged by 8 images in vertical and 8 images in horizontal (eight lines x eight columns). The lines in the display area are called L1, L2, . . . , L8 in the order from the top. Here, when the cross key 70 is pushed downward, the images in the index screen 202 move upward as shown in FIG. 2B.

FIG. 2B is a schematic view showing a state after scrolling by one line from the state in FIG. 2A. In FIG. 2B, the images (the numbers 1 through 8) on the top line (L1) in FIG. 2A move out of the index screen 202 and are disappeared due to the upward scrolling. Instead, the images of the numbers 65 through 72 newly move into the bottom line (L8) and are displayed on the index screen 202. When a user keeps pushing the cross key 70 downward, the images continue scrolling upward. FIG. 2C is a schematic view showing a state after scrolling by eight lines (namely, the images exactly displayed on one screen simultaneously) from the state in FIG. 2A by continuing scrolling upward. The images of the numbers 1 through 64 on eight lines move out of the index screen 202 and are disappeared, and the images of the numbers 65 through 72 move to the top line (L1) instead.

The digital camera of this embodiment moves the images on the index screen 202 at the speed that takes 0.5 seconds to scroll by one line in the first stage in which the user starts to push the cross key 70 downward. Therefore, it takes 4.0 seconds (=0.5 seconds×8 lines) from the state in FIG. 2A to the state in FIG. 2C.

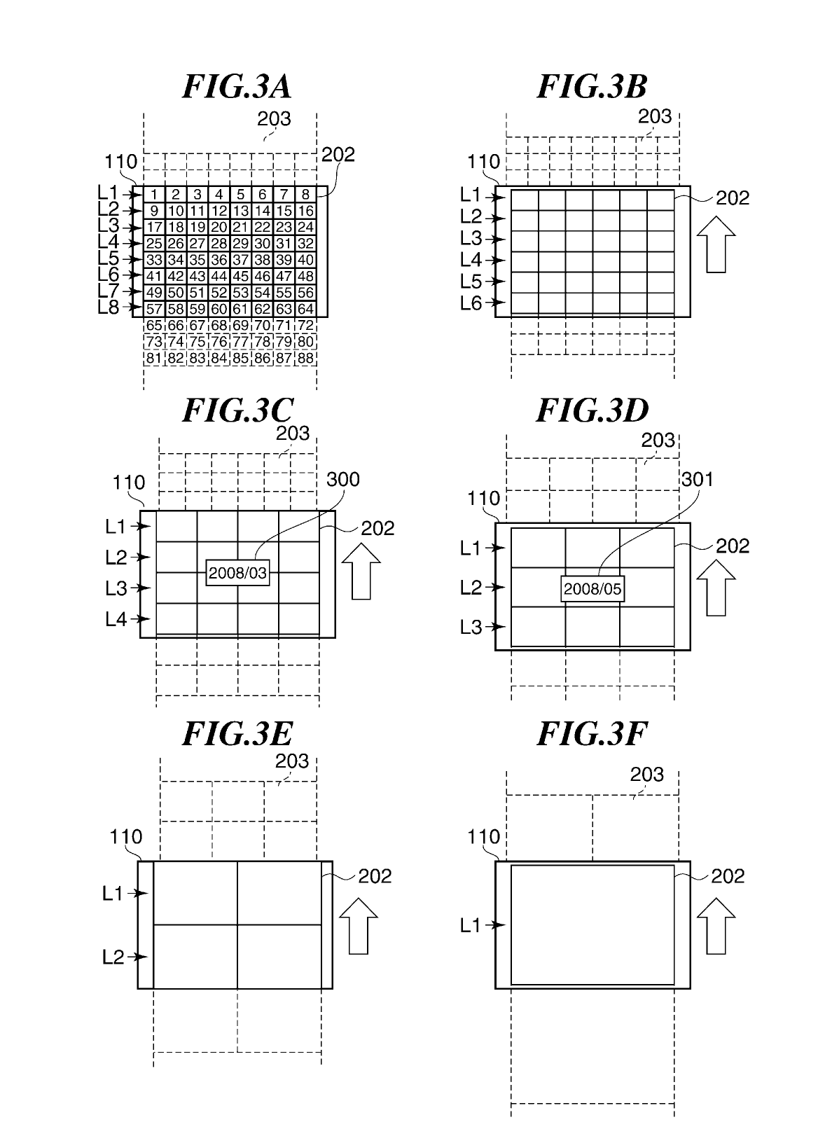

Next, display modes of the index screen 202 on the display unit 110 according to a scroll speed will be described with reference to FIG. 3A through FIG. 3F.

In an initial state shown in FIG. 3A, a total of 64 images in which 8 images per line (8 columns) are multiplied by 8 lines of L1 through L8 are arranged in the index screen 202 displayed on the display unit 110.

When the cross key 70 is kept pushing downward beyond 4 seconds in this state, the scrolling speed of the index screen 202 upward increases. In connection with it, as shown in FIG. 3B, the number of the images displayed on the index screen 202 becomes a total of 36 images in which 6 images per line (6 columns) are multiplied by 6 lines of L1 through L6, and the size of an image is enlarged. Here, the number of the images to be displayed is reduced as compared with the state shown in FIG. 3A by thinning out the images while leaving high priority images. Accordingly, the moving speed of the display area in all the images by scrolling increases while displaying the images in the larger size than the state shown in FIG. 3A. The moving speed of the display area here is the moving speed of the display area in all the images that are targets to be displayed in the initial state shown in FIG. 3A rather than the moving speed of the images displayed on the display unit 110. For example, the moving speed is the speed of the display area moved from the state displaying the images of the numbers around 1 through 64 to the state displaying the images of the numbers around 641 through 704, when 1000 images of the numbers 1 through 1000 are targets to be displayed in the initial state. If the moving speed becomes faster, all the 64 images of the numbers 641 through 704 are not displayed as the images of the numbers around 641 through 704, the fewer numbers of images are displayed in larger size. The method of thinning out according to the priority of the images to display will be mentioned later.

When the cross key 70 is kept pushing downward beyond 8 seconds from the initial state, the scrolling speed of the images upward on the index screen 202 further increases as shown in FIG. 3C. The number of the images displayed on the index screen 202 is further reduced to a total of 16 images in which 4 images per line are multiplied by 4 lines of L1 through L4, and the size of an image becomes larger than that in FIG. 3B.

When the cross key 70 is kept pushing downward beyond 12 seconds from the initial state, the scrolling speed of the images upward on the index screen 202 becomes higher than that in FIG. 3C as shown in FIG. 3D. The number of the images displayed on the index screen 202 is further reduced to a total of 9 images in which 3 images per line are multiplied by 3 lines of L1 through L3, and the size of an image becomes larger than that in FIG. 3C.

In FIG. 3C and FIG. 3D, date indications 300 and 301 are superimposed on the index screen 202 so as to grasp shooting dates of the images displayed on the index screen 202 during the high speed scrolling.

When the date indications 300 and 301 are superimposed on the index screen 202, the display areas of the date indications 300 and 301 can be translucent so as to keep the visibility of the background images. The date indications 300 and 301 can be displayed on the index screen 202 only in predetermined periods when the year or the month of the shooting dates of the background images changes by scrolling. It should be noted that the date indications 300 and 301 can be displayed at any positions in the index screen 202.

When the cross key 70 is kept pushing downward beyond 16 seconds from the initial state, the scrolling speed of the images upward on the index screen 202 becomes higher than that in FIG. 3D as shown in FIG. 3E. The number of the images displayed on the index screen 202 is further reduced to a total of 4 images in which 2 images per line are multiplied by 2 lines of L1 and L2, and the size of an image becomes larger than that in FIG. 3D.

When the cross key 70 is kept pushing downward beyond 20 seconds from the initial state, the scrolling speed of the images upward on the index screen 202 becomes higher than that in FIG. 3E as shown in FIG. 3F. The number of the images displayed on the index screen 202 is further reduced to a total of 1 image in which 1 image per line is multiplied by 1 line of L1, and the size of an image becomes larger than that in FIG. 3E and an image occupies the whole screen.

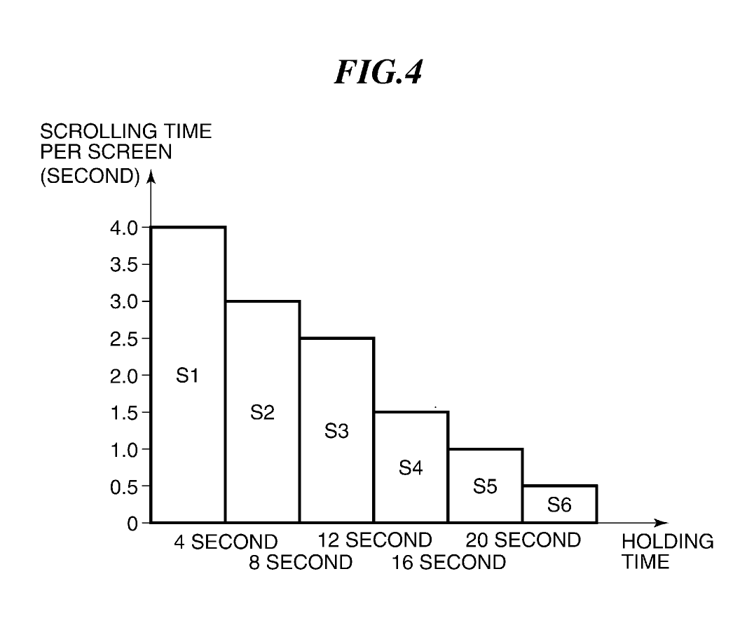

FIG. 4 is a graph showing a relationship between a period during which the cross key 70 is pushed and held in a predetermined direction (a holding time) and a scrolling time per screen of the display unit 110.

As shown in FIG. 4, when the holding time of the cross key 70 is not beyond 4 seconds, the scrolling time (a time period while the same image data moves from the bottom to the top of the display area and then disappears) is 4 seconds, and the number of images per screen of the display unit 110 is 64 images that are arranged by 8 images in vertical and 8 images in horizontal. Namely, the moving speed (scrolling speed) V1 of the images is given by V1=H/4 (m/s), where H (m) is a height of the display area for one screen on the display unit 110.

When the holding time of the cross key 70 exceeds 4 seconds and is not beyond 8 seconds, the scrolling time per screen of the display unit 110 is 3 seconds, and the number of the images per screen is 36 images that are arranged by 6 images in vertical and 6 images in horizontal. That is, the scrolling speed V2 is given by V2=H/3 (m/s).

When the holding time of the cross key 70 exceeds 8 seconds and is not beyond 12 seconds, the scrolling time per screen of the display unit 110 is 2.5 seconds, and the number of the images per screen is 16 images that are arranged by 4 images in vertical and 4 images in horizontal. That is, the scrolling speed V3 is given by V3=H/2.5 (m/s).

When the holding time of the cross key 70 exceeds 12 seconds and is not beyond 16 seconds, the scrolling time per screen of the display unit 110 is 1.5 seconds, and the number of the images per screen is 9 images that are arranged by 3 images in vertical and 3 images in horizontal. That is, the scrolling speed V4 is given by V4=H/1.5 (m/s).

When the holding time of the cross key 70 exceeds 16 seconds and is not beyond 20 seconds, the scrolling time per screen of the display unit 110 is 1 second, and the number of the images per screen is 4 images that are arranged by 2 images in vertical and 2 images in horizontal. That is, the scrolling speed V5 is given by V5=H (m/s).

When the holding time of the cross key 70 exceeds 20 seconds, the scrolling time per screen of the display unit 110 is 0.5 seconds, and the number of the images per screen is 1 image. That is, the scrolling speed V6 is given by V6=2H (m/s).

Thus, in this embodiment, the higher the scrolling speed is, the fewer the number of the displaying images is, and the larger the size of the images is. Since the number of the displaying images decreases as the scrolling speed becomes higher, the moving speed of the display area in all the images by scrolling becomes higher while enlarging the image size. It should be noted that the above mentioned relationship among the holding time of the cross key 70, the scroll time per screen, and the scrolling speed is one example, and can be changed arbitrarily.

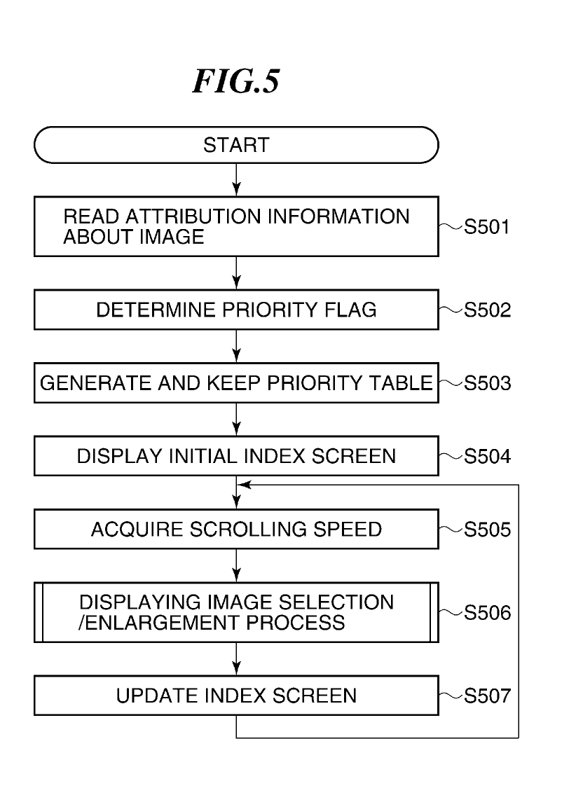

Next, an operation example of the digital camera of this embodiment will be described with reference to FIG. 5. Each process in FIG. 5 is achieved because the CPU 101 develops the program recorded in the nonvolatile memory 102 onto the memory 103 and executes.

In step S501, the CPU 101 reads attribution information of an image file of a static image or a moving image from the external storage medium 108 into the memory 103, and proceeds with the process to step S502. The attribution information has Exif (Exchangeable Image File Format) information about an image, attribution information like tag information recorded inside the image file, and attribution information about another file associated with the image file, for example. The attribution information has “date and time of shooting”, “a flag showing whether a person's face is included in image data”, “image quality at the time of shooting”, “zoom magnification”, “a counted value showing the number of person's faces included in image data”, “thumbnail (reduction image)”, etc. Moreover, the attribution information has “an ID value identifying a person registered in image data”, “a marker showing display in an index screen with a priority (set by a user)”, “F value showing an aperture of a lens at the time of shooting”, etc.

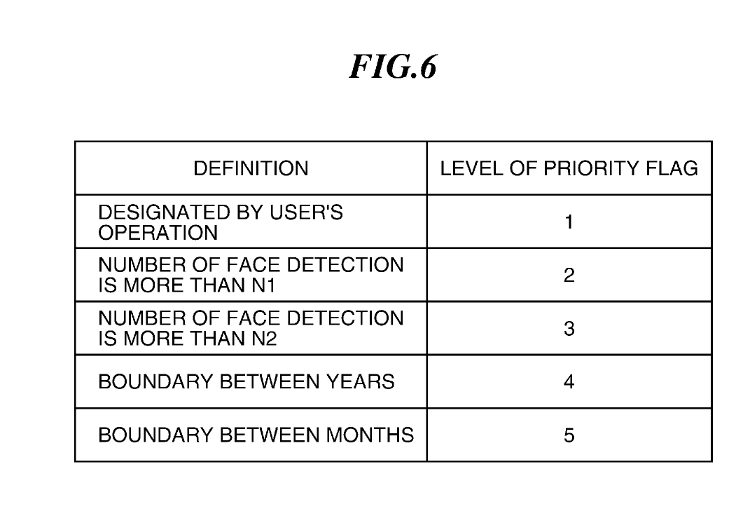

In the step S502, the CPU 101 determines the priority flag of each image according to addition conditions of the priority flag shown in FIG. 6 based on the attribution information read from the external storage medium 108.

The priority flag is used to select images displayed during a scroll operation mentioned later. FIG. 6 shows a list of the addition conditions of the priority flag.

In FIG. 6, the left column describes definitions that are used when the flag is given by evaluating attribution information, and the right column describes values of the priority flags. The flag value has five levels of 1 through 5, and the level 1 means the highest priority. The larger the flag value is, the lower the priority is.

The priority flag of the level 1 is given to an image that is designated by a user's predetermined operation to display preferentially. The CPU 101 determines whether the user has set to display the image preferentially based on whether the “marker showing display in an index screen with a priority (set by a user)” among the attribution information is ON.

The priority flag of the level 2 is given to an image of which the number of face detection is more than N1. When N1 is 5, an image in which many persons are shot can be selected. The priority flag of level 3 is given to an image of which the number of face detection is more than N2. When N2 is 1, an image in which a person is shot can be selected.

The priority flag of level 4 is given to an image of which a shooting date is in a boundary between years. For example, it is given to an image of the first date among images shot in each year like the image of the first date among images shot in 2008. The priority flag of level 5 is given to an image of which a shooting date is in a boundary between months. For example, it is given to an image of the first date among images shot in each month like the image of the first date among images shot in May in 2008.

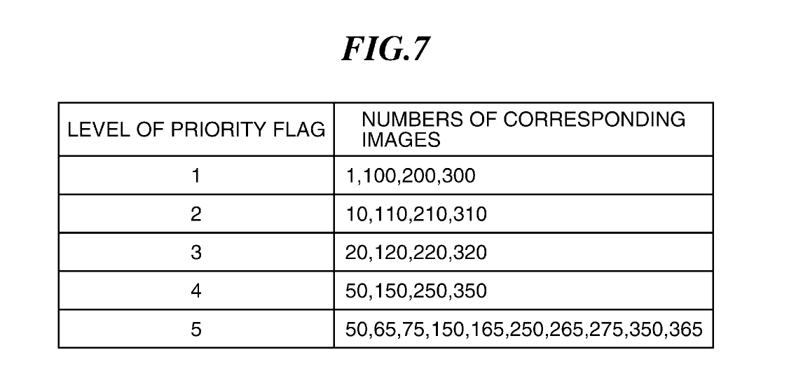

In step S503 in FIG. 5, the CPU 101 generates a priority table by classifying the images by the level of the priority flag according to the level of the priority flag given to each image in the step S502, and stores (keeps) the generated table into the memory 103. FIG. 7 shows an example of the priority table. In FIG. 7, the left column describes the level of the priority flag and the right column describes the numbers of the images corresponding to the levels of the priority flag.

In step S504, the CPU 101 displays an initial screen of the index screen mentioned above in FIG. 3A onto the display unit 110. The initial screen of the index screen displays all the images that are targets to be displayed on the index screen, without referring to the priority table held in the step S503. The CPU 101 acquires data of a main image included in an image file or a thumbnail included in attribution information from the external storage medium 108, decodes and resizes the acquired data to form an image, and displays the image on the index screen. Although the images are sorted by date and time of shooting (an order of the file number) basically, they may be sorted by another sorting order.

In step S505, the CPU 101 acquires the scrolling speed v. A scrolling can be performed by the operation to the cross key 70, the controller wheel 73, or the touch panel, as mentioned above. The scrolling speed is determined by the holding time to push the cross key 70, the rotation speed of the rotary operation to the controller wheel 73, or the moving speed of the touch position to the touch panel. The CPU 101 acquires the current scrolling speed v determined by these operations by the user.

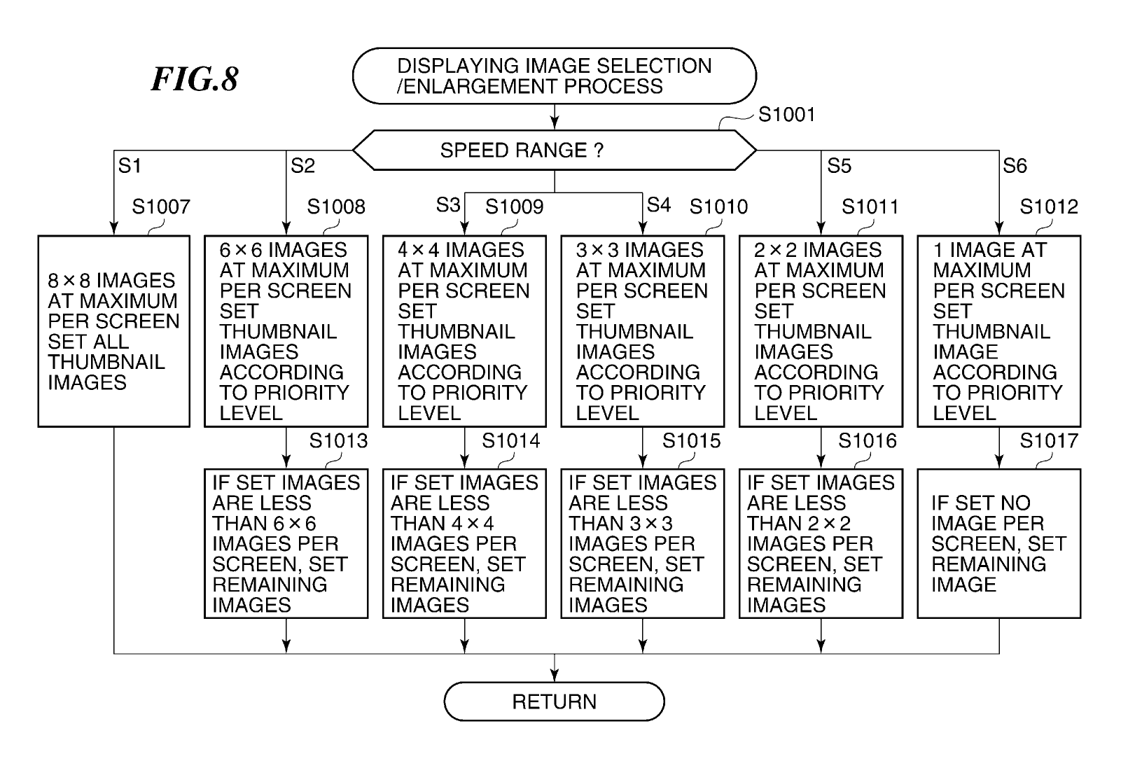

In step S506, the CPU 101 executes a displaying image selection/enlargement process for 6 speed ranges S1 through S6 based on the scrolling speed acquired in the step S505. Details of the process will be described later with reference to FIG. 8.

In step S507, the CPU 101 displays the images set in the step S506 on the index screen. That is, the CPU 101 reads the main image or the thumbnail of the image set in the step S506 from the external storage medium 108, decodes, resizes, and displays it. Then, since the CPU 101 returns the process to the step S505 and repeats the process, the index screen is dynamically updated according to the scrolling speed.

FIG. 8 shows an example of the displaying image selection/enlargement process executed for the 6 speed ranges S1 through S6. The definitions of the speed ranges S1 through S6 are as follows.

S1: |v|≦V1

S2: V1<|v|≦V2

S3: V2<|v|≦V3

S4: V3<|v|≦V4

S5: V4<|v|≦V5

S6: V5<|v|

In step S1001 in FIG. 8, the CPU 101 determines which of the speed ranges S1 through S6 corresponds to the scrolling speed acquired in the step S505. When it is determined that the scrolling speed falls within the speed range S1, the process proceeds to step S1007.

In the step S1007, the CPU 101 sets 64 images in an 8×8 matrix that will be displayed on the index screen 202 according to date and time of shooting. All the images become targets to be displayed on the index screen. In this case, the priority table is not referred. Next, the process returns to the step S507 in FIG. 5.

When the CPU 101 determines that the scrolling speed falls within the speed range S2 in the step S1001, the process proceeds to step S1008.

In the step S1008, the CPU 101 sets 36 images in a 6×6 matrix that will be displayed on the index screen 202 by selecting images in the decreasing order of the level of the priority flag with reference to the priority table stored in the memory 103 in the step S503, and proceeds with the process to step S1013. When the CPU 101 detects scrolling by the operation of the cross key 70 under the condition where the 36 images are displayed on the index screen 202, images are selected from the images that are displayed at the speed range S1. For example, when one-line scrolling is detected under the condition where 36 images are displayed, the CPU 101 selects 36 images from 64 images from the number 9 through the number 72 (see FIG. 2B), which will be displayed when scrolling one line at the speed range 1, according to the level of the priority flag defined in the priority table.

In step S1013, the CPU 101 determines whether the number of the images set in the step S1008 is less than 36 images of the 6×6 matrix. If the number of images to which the priority flags are attached among the images included in the display area defined by the current scroll position is less than 36, the number of the images set in the step S1008 is less than 36. When the number of the set images is not less than 36, the CPU 101 returns the process to the step S507 in FIG. 5. When the number of the set images is less than 36, the CPU 101 selects and set images from images other than the images set in the step S1008 so that the number of the set images reaches 36, and then, returns the process to the step S507 in FIG. 5.

The images may be selected in the order of the shooting date, may be selected by every fixed number, or may be selected at random. However, the images that have been scrolled and moved out of the screen are excepted from the parent population for selection during a period of continuous scrolling in the same direction. This is to prevent the images that were scrolled out of the screen from displaying again during the scrolling in the same direction.

When the CPU 101 determines that the scrolling speed falls within the speed range S3 in the step S1001, the process proceeds to step S1009.

In the step S1009, the CPU 101 sets 16 images in a 4×4 matrix that will be displayed on the index screen 202 by selecting images in the decreasing order of the level of the priority flag with reference to the priority table stored in the memory 103 in the step S503, and proceeds with the process to step S1014.

In step S1014, the CPU 101 determines whether the number of the images set in the step S1009 is less than 16 images of the 4×4 matrix. When the number of the set images is not less than 16, the CPU 101 returns the process to the step S507 in FIG. 5. When the number of the set images is less than 16, the CPU 101 selects and set images from images other than the images set in the step S1009 so that the number of the set images reaches 16, and then, returns the process to the step S507 in FIG. 5.

When the CPU 101 determines that the scrolling speed falls within the speed range S4 in the step S1001, the process proceeds to step S1010.

In the step S1010, the CPU 101 sets 9 images in a 3×3 matrix that will be displayed on the index screen 202 by selecting images in the decreasing order of the level of the priority flag with reference to the priority table stored in the memory 103 in the step S503, and proceeds with the process to step S1015.

In step S1015, the CPU 101 determines whether the number of the images set in the step S1010 is less than 9 images of the 3×3 matrix. When the number of the set images is not less than 9, the CPU 101 returns the process to the step S507 in FIG. 5. When the number of the set images is less than 9, the CPU 101 selects and set images from images other than the images set in the step S1010 so that the number of the set images reaches 9, and then, returns the process to the step S507 in FIG. 5.

When the CPU 101 determines that the scrolling speed falls within the speed range S5 in the step S1001, the process proceeds to step S1011.

In the step S1011, the CPU 101 sets 4 images in a 2×2 matrix that will be displayed on the index screen 202 by selecting images in the decreasing order of the level of the priority flag with reference to the priority table stored in the memory 103 in the step S503, and proceeds with the process to step S1016.

In step S1016, the CPU 101 determines whether the number of the images set in the step S1011 is less than 4 images of the 2×2 matrix. When the number of the set images is not less than 4, the CPU 101 returns the process to the step S507 in FIG. 5. When the number of the set images is less than 4, the CPU 101 selects and set images from images other than the images set in the step S1011 so that the number of the set images reaches 4, and then, returns the process to the step S507 in FIG. 5.

When the CPU 101 determines that the scrolling speed falls within the speed range S6 in the step S1001, the process proceeds to step S1012.

In the step S1012, the CPU 101 sets an image that will be displayed on the index screen 202 by selecting an image having the highest level of the priority flag with reference to the priority table stored in the memory 103 in the step S503, and proceeds with the process to step S1017.

In step S1017, the CPU 101 determines whether no image is set in the step S1012. When the image is set, the CPU 101 returns the process to the step S507 in FIG. 5. When no image is set, the CPU 101 selects and set an image from other images, and then, returns the process to the step S507 in FIG. 5.

Although this embodiment determines the speed ranges S1 through S6 based on the scrolling speeds, the factor of the determination is not limited to the scrolling speed. For example, the holding time of the cross key 70, the rotation speed of the rotary operation to the controller wheel 73, or the moving speed of the touch position by a drag or a flick onto the touch panel is acquired, and the speed ranges S1 through S6 can be directly determined by the acquired value.

Here, an image in the index screen 202 displayed on the display unit 110 at the speed range S2 is larger than an image at the speed range S1. In the same manner, an image at the speed range S3 is larger than an image at the speed range S2, an image at the speed range S4 is larger than an image at the speed range S3, an image at the speed range S4 is larger than an image at the speed range S5, an image at the speed range S6 is larger than an image at the speed range S5.

When the user cancels the operation of instructing the scrolling, the CPU 101 gradually reduces the size of images in the index screen 202 displayed on the display unit 110 and increases the number of images that are displayed per screen as a lapsed time, and then shifts to the initial state.

For example, when the holding state of the cross key 70 is canceled under the condition where 4 images of the 2×2 matrix are displayed as shown in FIG. 3E, the index screen 202 is changed to display 9 images of the 3×3 matrix as shown in FIG. 3D after a predetermined time lapses. Then, whenever the predetermined time lapses, the index screen 202 is changed to display 16 images as shown in FIG. 3C, to display 36 images as shown in FIG. 3B, and to display 64 images as shown in FIG. 3A. In this case, it is possible to apply known screen effects such as fading, zooming when the index screen is changed.

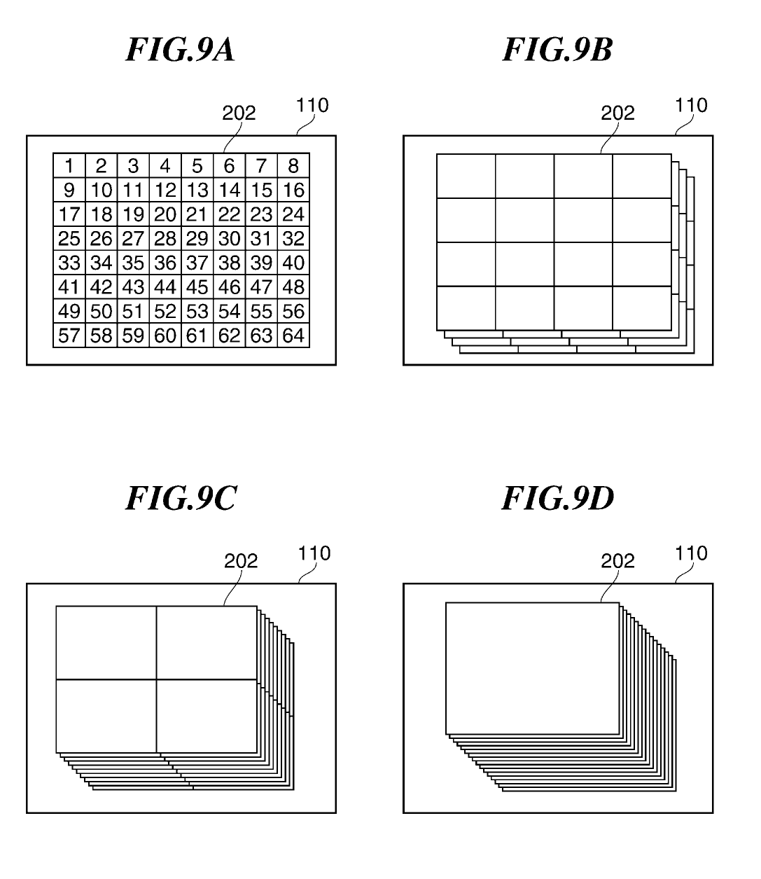

Here, in order to show intuitively that the images displayed on one screen are thinned out as the scrolling speed increases, the displays shown in FIGS. 3A through 3F may be replaced with the displays shown in FIGS. 9A through 9D. In the display method shown in FIGS. 9A through 9D, the images displayed on one screen are thinned out and the size of the displayed image increases as the scrolling speed increases, and an overlap of the disappeared images are expressed in a depth direction in order to showing that the number of thinned out images increases as the scrolling speed increases. FIG. 9A and FIG. 3A show the similar display states. FIGS. 9B, 9C, and 9D are displayed under the corresponding conditions in FIGS. 3C, 3E, and 3D, respectively. Even if scrolling speed goes up by displaying in this way and the display size per image is large by it, the movement speed of the display rectangle in all the images by scroll is also quick simultaneously—to that extent—it can be shown to both users.

As described above, according to the embodiment, since the variation of the scrolling speed of the index screen from low speed to high speed increases the image size and decreases the number of images displayed in the screen, the visibility of picked-up images during the scrolling operation improves. Accordingly, a user can quickly search a desired image from massive images listed onto the display unit 110 during the scrolling operation.

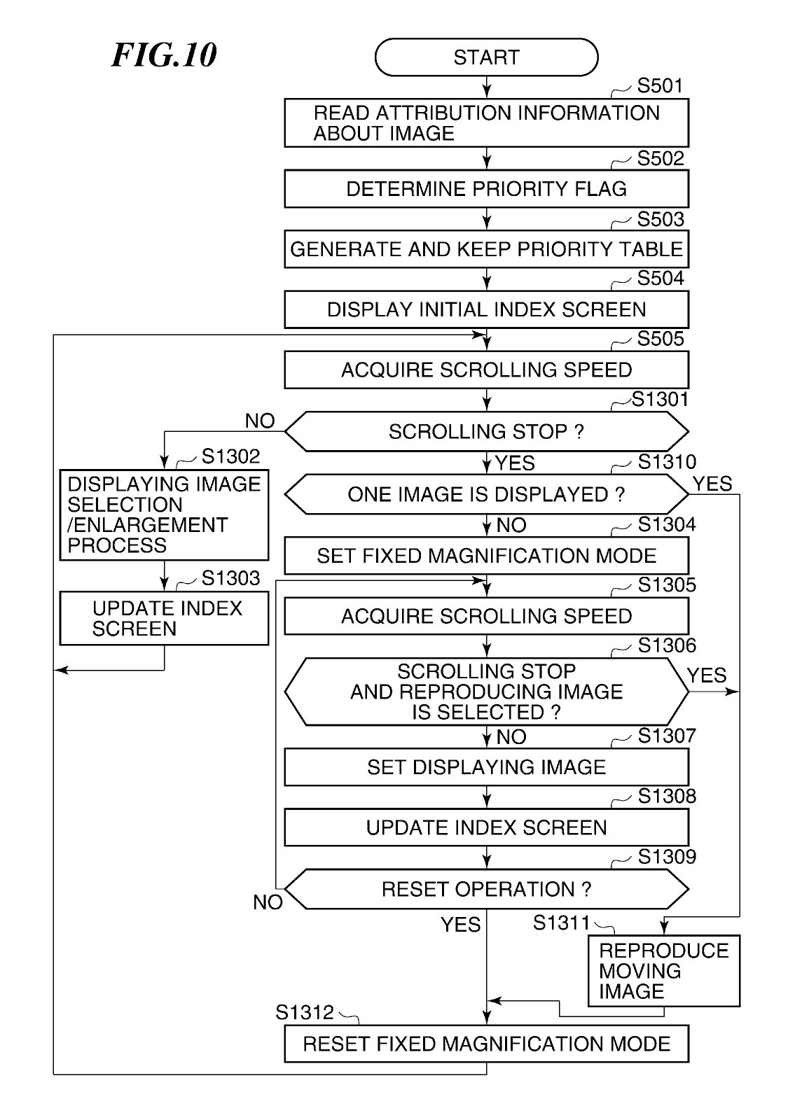

Next, an operation of the digital camera 100 as a second embodiment of the display control apparatus according to the present invention will be described with reference to FIG. 10. It should be noted that duplicated sections or corresponding section with respect to the above-mentioned first embodiment will be described by diverting the figures and the signs.

FIG. 10 is a flowchart showing an example of an operation of the digital camera 100 of the second embodiment. Each process in FIG. 10 is achieved because the CPU 101 develops the program stored in the nonvolatile memory 102 onto the memory 103 and executes. It should be noted that this embodiment is different from the first embodiment in the process after the step S505 in the flowchart in FIG. 5. Therefore, only the different points will be described.

In step S1301 in FIG. 10, the CPU 101 determines whether the user releases the hold of the cross key 70 to stop the scrolling operation on the index screen 202. When the scrolling operation stops, the CPU proceeds with the process to step S1310. When the scrolling operation does not stop, the CPU 101 proceeds with the process to step S1302. Since the processes in steps S1302 and S1303 are identical to that in the steps S506 and S507, respectively, the descriptions thereof are omitted.

In step S1310, the CPU 101 determines whether the index screen displayed on the display unit 110 includes only one image (see FIG. 3F). Then, when the index screen includes only one image, the CPU 101 proceeds with the process to step S1311. If not, the process proceeds to step S1304.

In the step S1311, the CPU 101 reproduces a moving image on the display unit 110, when the main image corresponding to the thumbnail image currently displayed is a moving image. After reproduction is completed, it progresses to step S1312.

In the step S1304, the CPU 101 sets a fixed magnification mode, and proceeds with the process to step S1305. In the fixed magnification mode, the CPU 101 suspends the selection of displaying image and the change of the image size according to the scrolling speed, and keeps the display size at the time of stopping the scrolling operation in the step S1301. The CPU 101 displays all the images on the display unit 110 regardless of the priority after stopping the scrolling operation. For example, when the scrolling operation is stopped under the condition where 4 images of the 2×2 matrix, all the images are displayed on the display unit 110 in the 4 images format while scrolling after that.

In the step S1305, the CPU 101 detects the scrolling speed on the index screen 202 based on the operating condition of the cross key 70 by the user, and proceeds with the process to step S1306.

In the step S1306, the CPU 101 determines whether the scrolling operation on the index screen 202 is stopped by the user's operation of the cross key 70 and one image is selected to reproduce. Then, when the scrolling operation on the index screen 202 is stopped and one image is selected to reproduce, the CPU 101 reproduces the moving image selected in the step S1311. If not, the process proceeds to step S1307.

In the step S1307, the CPU 101 sets all the images to be displayed regardless of the priority flag, and proceeds with the process to step S1308.

In the step S1308, the CPU 101 updates the index screen displayed on the display unit 110 based on the images set in the step S1307, and proceeds with the process to step S1309.

In the step S1309, the CPU 101 determines whether a display reset button (not shown) is pushed to execute a reset operation. When the reset operation is not executed, the process returns to the step S1305. When the reset operation is executed, the process proceeds to step S1312.

In the step S1312, the CPU 101 resets the fixed magnification mode, and proceeds with the process to the step S505. Since the fixed magnification mode is reset according to the reset operation, 64 images of the 8×8 matrix are displayed on the index screen 202 that is displayed on the display unit 110, and the initial screen state is set.

When returning to the initial screen state, the images displayed on the index screen 202 before the reset operation are also included and displayed on the display unit 110. For example, when the reset operation is performed under the condition where the 4 images are displayed, 64 images including these 4 images are displayed on the display unit 110 to shift to the initial screen state.

As described above, in this embodiment, since the moving image is automatically reproduced when the scrolling operation stops under the condition where one image is enlarged and displayed on the index screen 202, the operation is simplified.

In this embodiment, since the number of displaying images and the image size on the index screen 202 at the time of stopping the scrolling operation are kept, the search of the index screen 202 after stopping the scrolling operation can be performed comfortably. The other configurations and operation effects are the same as that of the above-mentioned first embodiment.

It should be noted that the control by the CPU 101 in the above-mentioned embodiments may be executed by one piece of hardware or may be shared by a plurality of pieces of hardware to control the whole apparatus.

Although the embodiments of the invention have been described, the present invention is not limited to the above-mentioned embodiments, the present invention includes various modifications as long as the concept of the invention is not deviated. The above mentioned embodiments are examples of the present invention, the embodiments can be combined suitably.

In the embodiments mentioned above, although the present invention is applied to the digital camera, it is not limited to this example.

That is, the present invention can be applied to any display control apparatuses that display images simultaneously, such as a PC, a PDA, a cell phone, a portable image viewer, a display unit of a printer for selecting a print image and for checking, and a digital photograph frame. Especially, it is more effective when the present invention is applied to small display units of portable electronic devices (a digital camera, a cell phone, a PDA, a portable music player, a handheld game machine, etc.).

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-175571, filed on Aug. 4, 2010, which is hereby incorporated by reference herein in its entirety.

What is claimed is:

1. A display control apparatus that controls a display unit to display a list of images, comprising:
a display control unit configured to control so that the images are displayed in a predetermined order on the display unit;
a scrolling control unit configured to control so as to scroll the images displayed on the display unit; and
a control unit configured to control said display control unit to decrease the number of images displayed in a screen and to increase a size of the displayed images when said scrolling control unit changes scrolling speed from low speed to high speed.

2. The display control apparatus according to claim 1, wherein said control unit controls said display control unit to decrease the number of images that are targets to be displayed as the scrolling speed increases.

3. The display control apparatus according to claim 2, further comprising an acquisition unit configured to acquire attribution information about an image,
wherein said control unit selects images that are targets to be displayed based on the attribution information acquired by said acquisition unit.

4. The display control apparatus according to claim 3, wherein the attribution information includes information given to improve priority as the target to be displayed according to a user's operation.

5. The display control apparatus according to claim 3, wherein the attribution information includes information about faces detected from the image.

6. The display control apparatus according to claim 3, wherein the attribution information includes information about date of shooting.

7. The display control apparatus according to claim 2, wherein said display control unit displays in a form to express overlap in a depth direction of the image to be displayed, and wherein the depth of the overlap becomes deeper as said scrolling control unit increases the scrolling speed.

8. The display control apparatus according to claim 1, wherein said display control unit displays information about date of shooting on the display unit when said scrolling control unit increases the scrolling speed.

9. The display control apparatus according to claim 1, further comprising a receiving unit configured to receive a user's operation to instruct scrolling images,
wherein said scrolling control unit controls the scrolling speed according to the operation received by said receiving unit, and
wherein said control unit controls said display control unit to decrease the number of images displayed in a screen and to increase a size of the displayed images when the operation received by said receiving unit instructs to change the scrolling speed from low speed to high speed.

10. The display control apparatus according to claim 9, wherein said scrolling control unit changes the scrolling speed from low speed to high speed when pushed time of an operating member as said receiving unit is beyond a threshold value.

11. The display control apparatus according to claim 9, wherein said scrolling control unit changes the scrolling speed from low speed to high speed when speed of a rotary operation to an operating member as said receiving unit is beyond a threshold value.

12. The display control apparatus according to claim 9, wherein said scrolling control unit changes the scrolling speed from low speed to high speed when moving speed of a touch position to a touch operation member as said receiving unit is beyond a threshold value.

13. The display control apparatus according to claim 1, wherein said control unit gradually reduces the display size of the images that said display control unit displays, and increases the number of the images to be displayed on one screen when said scrolling control unit stops the scrolling operation.

14. The display control apparatus according to claim 1, further comprising a determination unit configured to determine whether the display unit displays one image when said scrolling control unit stops the scrolling operation,
wherein said control unit controls the display unit to reproduce a moving image when said determination unit determines that the display unit displays one image.

15. A control method for a display control apparatus that controls a display unit to display a list of images, the control method comprising:
a display control step of controlling so that the images are displayed in a predetermined order on the display unit;
a scrolling control step of controlling so as to scroll the images displayed on the display unit; and
a control step of controlling so as to decrease the number of images displayed in a screen in said display control step and to increase a size of the displayed images when the scrolling speed is changed from low speed to high speed in said scrolling control step.

16. A non-transitory computer-readable storage medium storing a control program causing a computer to execute a control method for a display control apparatus that displays a list of images on a display unit, the control method comprising:
a display control step of controlling so that the images are displayed in a predetermined order on the display unit;
a scrolling control step of controlling so as to scroll the images displayed on the display unit; and
a control step of controlling so as to decrease the number of images displayed in a screen in said display control step and to increase a size of the displayed images when the scrolling speed is changed from low speed to high speed in said scrolling control step.
